(19) United States
(12) Patent Application Publication
(10) Pub. No.: US 2021/0078816 A1
(43) Pub. Date: Mar. 18, 2021

(54) RECORDING MEDIUM DETECTION DEVICE AND IMAGE FORMING APPARATUS

(71) Applicant: Konica Minolta, Inc.,, Tokyo (JP)

(72) Inventors: Yumiko Izumiya, Tokyo (JP); Satoshi Ogata, Tokyo (JP); Kazutoshi Yoshimura, Tokyo (JP); Hitoshi Asano, Toyokawa-shi (JP); Hirotada Seki, Toyokawa-shi (JP); Akimasa Ishikawa, Toyokawa-shi (JP); Masashi Sugano, Tokyo (JP); Tsuyoshi Yoneyama, Tokyo (JP); Hiroyuki Maruyama, Toyokawa-shi (JP)

(21) Appl. No.: 17/020,212

(22) Filed: Sep. 14, 2020

(30) Foreign Application Priority Data
Sep. 12, 2019 (JP) 2019-165829

(51) Int. Cl. B65H 7/14; B65H 29/12; B65H 43/08

(52) U.S. Cl. CPC B65H 7/14; B65H 29/125; B65H 2511/13; B65H 2515/112; B65H 2553/46; B65H 43/08

(57) ABSTRACT

Provided is a recording medium detection device which prevents the decline in productivity. The recording medium detection device comprises a first detecting section and a second detecting section. The first detecting section performs a first adjustment process and makes a detection of a recording medium being transported. The second detecting section is located more downstream than the first detecting section in the transportation direction of the recording medium, performs a second adjustment process which takes a longer time than the first adjustment process, and makes a detection of the recording medium being transported.

### CROSS-REFERENCE TO RELATED APPLICATIONS

The present invention claims priority under 35 U.S.C. § 119 to Japanese Patent Application No. 2019-165829 and 2019-165830 filed on Sep. 12, 2019, the entire content of which is incorporated herein by reference.

### BACKGROUND

### Technological Field

The present invention relates to a recording medium detection device which detects the thickness and type of a recording medium and an image forming apparatus including the recording medium detection device.

### Description of the Related Art

An image forming system includes an image forming apparatus for forming an image on a recording medium such as a sheet of paper, and a recording medium supply device for supplying a recording medium to the image forming apparatus. The image forming apparatus forms an image on the recording medium according to output job information. Before an image is formed in the image forming apparatus, the size or type of the recording medium is detected by a recording medium detection device.

In the related art, for example, Patent Literature 1 (JP-A-2018-76185) describes this kind of recording medium detection device. Patent Literature 1 describes a sheet material determination device which includes: information detecting portion to detect information on a sheet material by irradiating the surface of the sheet material by light emitting portion and making light receiving portion receive the light from the irradiated sheet material surface; and determining portion which determines the sheet material according to the sheet material information detected by the information detecting portion.

### CITATION LIST

### Patent Literature

Patent Literature 1: JP-A-2018-76185

### SUMMARY

However, in order to assure the detection accuracy, an optical detector which can change the detecting conditions requires the adjustment of detecting conditions at the time of turning on the power or according to the physical property values of the recording medium. In the technique described in Patent Literature 1, the recording medium detection device must be stopped while the adjustment is under way, which results in a decline in productivity.

The present invention has been made in view of the above problem and has an object to provide a recording medium detection device and an image forming apparatus which can prevent the decline in productivity.

To achieve the above object, according to an aspect of the present invention, a recording medium detection device reflecting one aspect of the present invention comprises: a first detecting section and a second detecting section. The first detecting section performs a first adjustment process and makes a detection of a recording medium being transported. The second detecting section is located more downstream than the first detecting section in the transportation direction of the recording medium, performs a second adjustment process which takes a longer time than the first adjustment process, and makes a detection of the recording medium being transported.

According to another aspect of the present invention, an image forming apparatus reflecting one aspect of the present invention comprises: an image forming section which forms an image on a recording medium; and a recording medium detection device which is located more upstream than the image forming section in the transportation direction of the recording medium and detects the recording medium. As the recording medium detection device, the above recording medium detection device is used.

### BRIEF DESCRIPTION OF THE DRAWINGS

The advantages and features provided by one embodiment of the invention will become more fully understood from the detailed description given hereinbelow and the appended drawings which are given by way of illustration only, and thus are not intended as a definition of the limits of the present invention:

FIG. 1 is a schematic diagram which shows the general configuration of the image forming system according to an embodiment of the present invention;

FIG. 2 is a block diagram which shows the hardware configuration of the image forming system according to the embodiment of the present invention;

FIG. 3 is a schematic diagram which shows the structure of the recording medium detection device according to the embodiment of the present invention;

FIG. 4 is a perspective view which shows the first detecting section of the recording medium detection device according to the embodiment of the present invention;

FIG. 5 is a perspective view which shows the driven roller of the recording medium detection device according to the embodiment of the present invention;

FIG. 6 is a plan view of the detection guide plate of the second detecting section of the recording medium detection device according to the embodiment of the present invention;

FIG. 7 is a schematic structure diagram which shows the lifting member and first detection unit of the second detecting section of the recording medium detection device according to the embodiment of the present invention;

FIG. 8 is a flowchart which shows the adjustment process (second adjustment process) of the second detecting section of the recording medium detection device according to the embodiment of the present invention;

FIG. 9 is a flowchart which shows detection operation of the recording medium detection device according to the embodiment of the present invention;

FIG. 10A and FIG. 10B are explanatory diagrams which indicate that the quantity of transmitted light differs depending on the recording medium thickness, in which FIG. 10A shows a thinner recording medium and FIG. 10B shows a thicker recording medium;

FIG. 11 is an explanatory diagram which indicates that the position of incidence of reflected light differs depending on the recording medium thickness, and

FIG. 12 is a flowchart which shows another example of detection operation of the recording medium detection device according to the embodiment of the present invention.

### DETAILED DESCRIPTION OF EMBODIMENTS

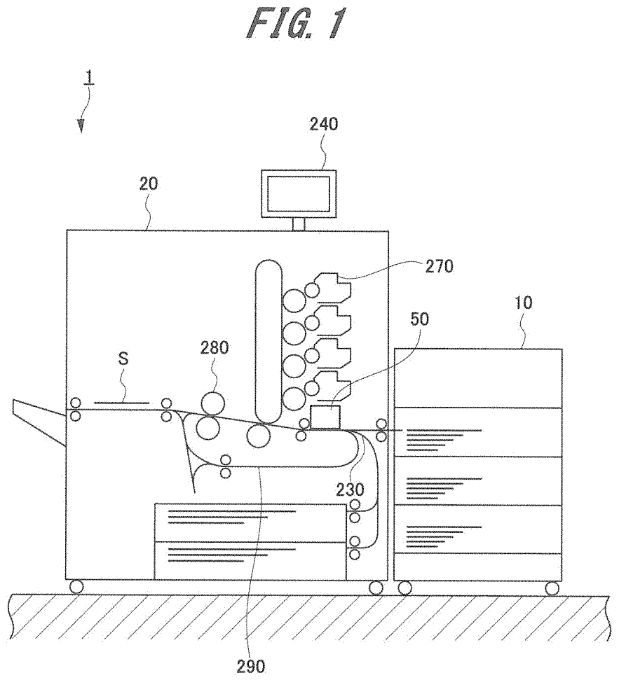

Hereinafter, an embodiment of the present invention will be described with reference to the drawings. A recording medium detection device and an image forming apparatus according to the embodiment of the present invention will be described with reference to FIGS. 1 to 12. In the figures, the same elements are designated by the same reference signs. The scope of the invention is not limited to the disclosed embodiment.

### 1. Embodiment of the Invention

### 1-1. Configuration of the Image Forming System

First, the general configuration of the image forming system according to an embodiment of the present invention (hereinafter called “the present embodiment”) is described below. FIG. 1 is a schematic configuration diagram of an image forming system 1 according to the present embodiment.

As shown in FIG. 1, the image forming system 1 includes a paper feed unit 10 for supplying a sheet of paper S as an example of a recording medium, and an image forming apparatus 20. The paper feed unit 10 and image forming apparatus 20 are each connected to a network such as a LAN and connected with each other via the network. In the image forming system 1, the paper feed unit 10 and image forming apparatus 20 are arranged side by side from the upstream side of the transportation path for the sheet S in the order of mention and connected in series.

The paper feed unit 10 is located on the most upstream side in the image forming system 1. The paper feed unit 10 includes a plurality of paper feed trays and can house a large volume of paper. The paper feed unit 10 supplies a sheet S housed in a paper feed tray to the image forming apparatus 20 by a paper conveyor.

Although the image forming system 1 which includes the paper feed unit 10 has been described above as an example, the image forming system 1 is not so limited and it may not include the paper feed unit 10.

The image forming apparatus 20 forms an image on the supplied sheet S according to output job information and image data. The image forming apparatus 20 forms an image on a sheet S, for example, by an electrophotographic method. The image forming apparatus 20 includes a paper conveyor 230, an operation display panel 240, an image forming section 270, a fixing section 280, and an inversion conveyor 290. The image forming apparatus 20 includes a sheet detection device 50 which detects the type, thickness, and so on of the sheet S.

The operation display panel 240, which serves as a warning section, is installed on the top of the chassis of the image forming apparatus 20. The operation display panel 240 is a display panel combined with a touch panel (operation section), which enables operation by the user and can display information.

The paper conveyor 230 transports the sheet S supplied from the paper feed unit 10 or a paper feed tray to the sheet detection device 50, image forming section 270, fixing section 280, inversion conveyor 290 or a paper delivery tray.

The image forming section 270 includes image forming units for a plurality of colors (cyan, magenta, yellow, black, and so on) and can form a color toner image on a sheet. The fixing section 280, to which the sheet with a toner image formed thereon is transported, is located downstream of the image forming section 270 in the sheet transportation direction.

The fixing section 280 fixes the toner image transferred to the sheet S, on the sheet S by pressurizing and heating the transported sheet S. The sheet S subjected to the fixing process by the fixing section 280 is transported to the inversion conveyor 290 or paper delivery tray by the paper conveyor 230.

The inversion conveyor 290 includes an inversion section which inverts the sheet S. The sheet S inverted upside down or back and forth by the inversion section is made to pass through the inversion conveyor 290 and transported to the upstream side of the image forming section 270 or the downstream side of the fixing section 280.

The sheet detection device 50 is located more upstream than the image forming section 270 of the image forming apparatus 20 in the sheet transportation direction. However, the location of the sheet detection device 50 is not so limited; instead, the sheet detection device 50 may be located, for example, at the discharge side of the paper feed tray which houses the sheet S, in the image forming apparatus 20.

The sheet detection device 50, as an example of the recording medium detection device, transports the sheet S transported from the paper feed unit 10 or a paper feed tray and detects the physical property values of the sheet S during a sheet setting process. Then, the sheet detection device 50 sends the obtained detection information to the image forming apparatus 20.

The physical property values of the sheet S which are detected by the sheet detection device 50 are, for example, the basis weight, thickness, surface nature, sheet base, color, and so on of the sheet S.

### 1-2. Hardware Configurations of the Devices

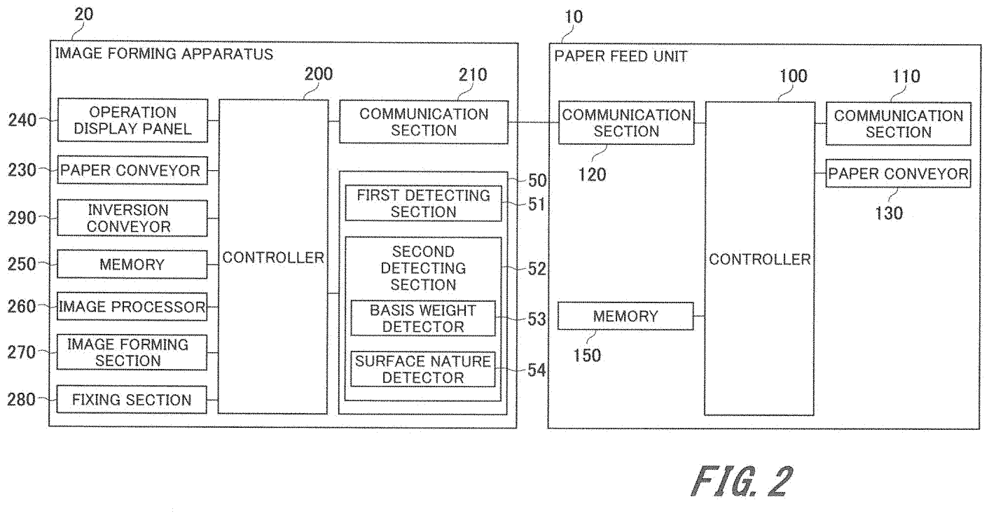

Next, the hardware configurations of the devices will be described referring to FIG. 2.

FIG. 2 is a block diagram which shows the hardware configurations of the devices of the image forming system 1.

First, the hardware configuration of the paper feed unit 10 is described below.

As shown in FIG. 2, the paper feed unit 10 includes a controller 100, communication sections 110 and 120, a paper conveyor 130, and a memory 150.

For example, the controller 100 has a CPU (Central Processing Unit). The controller 100 is connected to the communication sections 110 and 120, paper conveyor 130, and memory 150 through a system bus to control the entire paper feed unit 10.

The memory 150 is a volatile memory such as a RAM or a large-capacity nonvolatile memory. The memory 150 stores the program to be executed by the controller 100 and the like and is used as a working area for the controller 100.

The communication section 110 performs transmission and reception of data with an external device (client terminal, management device server or the like or mobile terminal) for the image forming system 1. The communication section 120 performs transmission and reception of data with the communication section 210 of the image forming apparatus 20.

Next, the hardware configuration of the image forming apparatus 20 will be described. The image forming apparatus 20 includes a controller 200, a communication section 210, the paper conveyor 230, the operation display panel 240, a memory 250, an image processor 260, the image forming section 270, the fixing section 280, the inversion conveyor 290, and the sheet detection device 50.

The controller 200, which serves as a judgment section, has, for example, a CPU (Central Processing Unit). The controller 200 is connected to the communication section 210, paper conveyor 230, operation display panel 240, memory 250, image processor 260, image forming section 270, fixing section 280, and inversion conveyor 290 through a system bus to control the entire image forming apparatus 20. The controller 200 also controls the paper feed unit 10 and sheet detection device 50 through the communication section 210. In short, according to the present embodiment, the controller 200 controls the entire image forming system 1.

The memory 250, which serves as a storage, is a volatile memory such as a RAM or a large-capacity nonvolatile memory. The memory 250 stores the program to be executed by the controller 200 and the like and is used as a working area for the controller 200. The memory 250 also stores sheet setting information which indicates the size and type of the sheet S which is specified. The items to specify the sheet S are, for example, the base color, paper type, basis weight, and so on of the sheet S.

The image processor 260 acquires image data from the job information received from outside and performs image processing. The image processor 260 performs various types of image processing with the received image data, including shading correction, image density adjustment, and image compression, as necessary under the control by the controller 200. Then, the image data processed by the image processor 260 is sent to the image forming section 270. The image forming section 270 receives the image data subjected to image processing by the image processor 260 and forms an image on the sheet S according to the image data.

The operation display panel 240 is a touch panel which includes a display such as a liquid crystal display (LCD) or organic ELD (Electro Luminescence Display). The operation display panel 240 is an example of the input/output section which displays a command menu for the user, information on acquired image data, and so on. Furthermore, the operation display panel 240 includes a plurality of keys and receives various instructions and data as characters and numerals which are entered through key operation by the user, and sends an input signal to the controller 200.

The sheet detection device 50 includes a first detecting section 51 and a second detecting section 52. The first detecting section 51 transports the sheet S and detects the thickness of the sheet S. The second detecting section 52 includes a basis weight detector 53 for detecting the basis weight of the sheet S transported by the first detecting section 51 and a surface nature detector 54 for detecting the surface nature. The information detected by the sheet detection device 50 is sent to the controller 200.

### 2. An Example of the Structure of the Sheet Detection Device

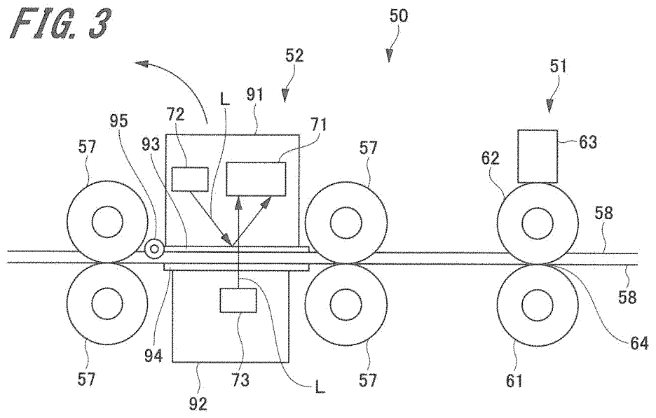

Next, the structure of the sheet detection device 50 will be described referring to FIGS. 3 to 7.

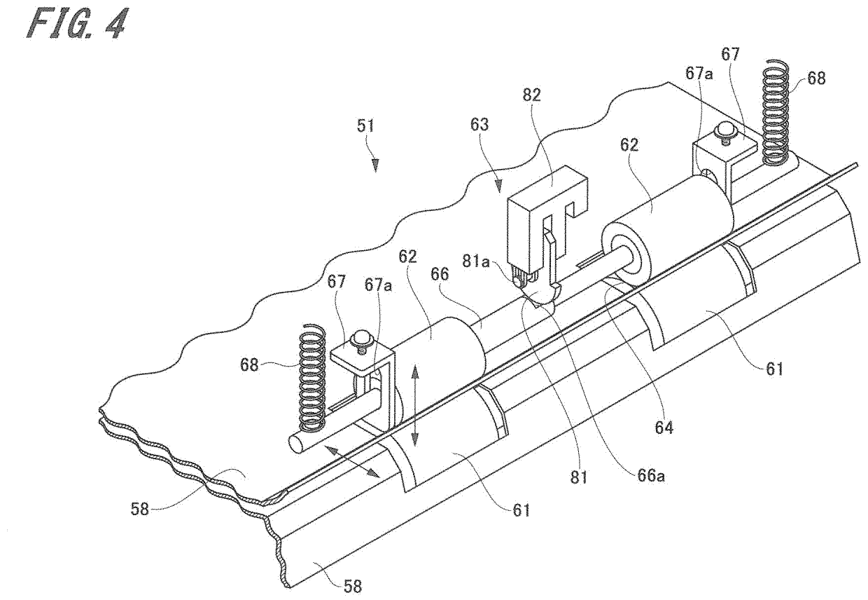

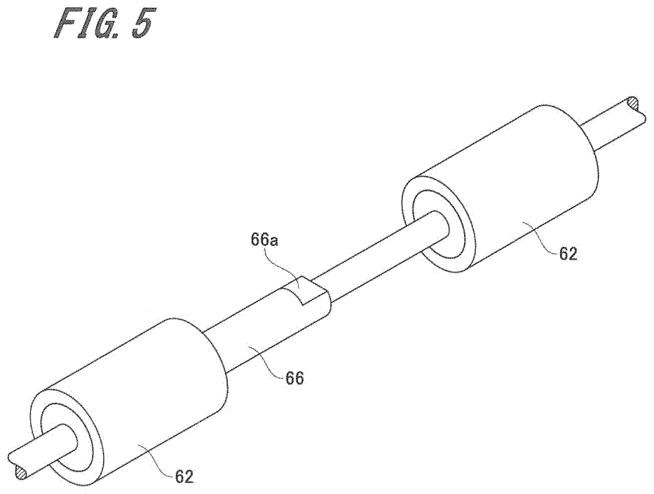

FIG. 3 is a schematic diagram which shows the sheet detection device 50. FIGS. 4 and 5 are perspective views which show the first detecting section 51.

As shown in FIG. 3, the sheet detection device 50 includes the first detecting section 51, the second detecting section 52, a plurality of conveyor rollers 57, and a pair of transportation guide plates 58. The transportation guide plates 58 face each other with a prescribed distance between them in the thickness direction which is perpendicular to the transportation direction of the sheet S and also perpendicular to the width direction of the sheet S.

The first detecting section 51 includes a drive roller 61 and a driven roller 62 which nip and transport the sheet, and a displacement detector 63. The drive roller 61, as the first roller, is rotated by a drive (not shown). The driven roller 62, as the second roller, is biased toward the drive roller 61 by a biasing member. The drive roller 61 and driven roller 62 come into contact with each other to form a nip part 64.

The displacement detector 63 detects the displacement of the driven roller 62 in the thickness direction. For example, the displacement detector 63 has a detection lever abutting on a displacement member whose position changes in the thickness direction along with the driven roller 62 and detects the displacement of the driven roller 62 in the thickness direction from the rotation angle of the detection lever. The displacement member may be, for example, a roller shaft which rotatably supports the driven roller 62, or the like.

The first detecting section 51 detects the thickness of the sheet S from the displacement of the driven roller 62 in the thickness direction when the sheet S is inserted in the nip part 64 between the drive roller 61 and driven roller 62. The first detecting section 51 transports the sheet S downstream in the transportation direction using the drive roller 61 and driven roller 62.

As shown in FIGS. 4 and 5, the first detecting section 51 includes two drive rollers 61, two driven rollers 62, the displacement detector 63, a roller shaft 66, a shaft support 67, and a biasing member 68. The drive roller 61 and driven roller 62 face each other in the thickness direction of the sheet S. The two drive rollers 61 are spaced from each other in the width direction and similarly the two driven rollers 62 are spaced from each other in the width direction. The axial direction of the drive roller 61 and driven roller 62 is parallel to the width direction of the sheet S being transported. The driven roller 62 is rotatably supported by the cylindrical roller shaft 66.

The roller shaft 66 is movably supported by the shaft support 67 located on the transportation guide plate 58. The rotation of the roller shaft 66 is restricted by a rotation restricting member (not shown). The shaft support 67 has a support hole 67a into which the roller shaft 66 is inserted. The support hole 67a is an oblong hole which extends by a given length along the thickness direction. The roller shaft 66 is supported slidably in the thickness direction along the support hole 67a of the shaft support 67.

The opening length of the support hole 67a in the transportation direction is longer than the diameter of the roller shaft 66. Therefore, a small clearance is generated between the roller shaft 66 and the support hole 67a in the transportation direction. The roller shaft 66 is supported by the shaft support 67 through the support hole 67a in a manner that it can move by a given length in the transportation direction.

The roller shaft 66 is biased toward the drive roller 61 by the biasing member 68. Therefore, the driven roller 62 supported by the roller shaft 66 is biased toward the drive roller 61. As the drive roller 61 rotates, the driven roller 62 also rotates together with the drive roller 61.

The biasing member 68 may be, for example, a compression coil spring. However, the biasing member 68 is not limited to a compression coil spring but it may be any of other various elastic members, such as a leaf spring or rubber.

The detection lever 81 of the displacement detector 63 abuts on the roller shaft 66. The displacement detector 63 includes the detection lever 81 abutting on the roller shaft 66, and a support part 82 for supporting the detection lever 81. The part of the detection lever 81 that abuts on the roller shaft 66 is virtually arc-shaped. The detection lever 81 is rotatably supported by the support part 82 through a rotation axis 81a. As the roller shaft 66 moves in the thickness direction, the detection lever 81 rotates around the support part 82. The displacement detector 63 detects the thickness of the sheet S from the rotation angle of the detection lever 81.

In the present embodiment, it is assumed that the thickness of the sheet S is detected from the rotation angle of the detection lever 81. However, the present invention is not so limited. Instead, the displacement detector 63 may use a measuring instrument or any other member that detects the displacement of the roller shaft 66 in the thickness direction.

Also, in the present embodiment, it is assumed that the roller shaft 66 is used as a displacement member and the detection lever 81 abuts on the roller shaft 66. However, the present invention is not so limited. Instead, an interlocking member whose position changes along with the roller shaft 66 in the transportation direction and thickness direction may be used as a displacement member. In that case, in the displacement detector 63, the detection lever 81 is made to abut on the interlocking member and the amount of displacement of the driven roller 62 in the thickness direction is detected from the amount of displacement of the interlocking member.

As mentioned above, the roller shaft 66 is supported by the shaft support 67 in a manner that it can move not only in the thickness direction but also in the transportation direction. Therefore, as the sheet S enters the nip part 64 between the drive roller 61 and driven roller 62, the driven roller 62 and the roller shaft 66 move in the transportation direction, following the sheet S. Consequently, the load which is generated when the sheet S enters the nip part 64 can be absorbed by the movement of the driven roller 62 in the transportation direction. This prevents paper jams in the nip part 64 between the drive roller 61 and driven roller 62.

A flat part 66a is formed on the outer circumference of the roller shaft 66 at the position of contact with the detection lever 81. The flat part 66a is formed by making a flat notch in part of the outer circumference of the roller shaft 66. The flat part 66a is parallel to the transportation direction of the sheet S. Thus, the flat part 66a is perpendicular to the thickness direction.

In addition, the length of the flat part 66a in the transportation direction is longer than the clearance between the roller shaft 66 and the support hole 67a in the transportation direction. In other words, the length of the flat part 66a in the transportation direction is longer than the maximum length for which the roller shaft 66 can move in the transportation direction. Consequently, even if the roller shaft 66 moves in the transportation direction for the maximum length, the detection lever 81 stays on the flat part 66a. As shown in FIG. 7, even when the roller shaft 66 moves in the transportation direction, the position of detection point P1 in the thickness direction does not change and thus the detection lever 81 does not rotate. This improves the detection accuracy of the sheet detection device 50.

As shown in FIG. 3, the second detecting section 52 is located more downstream than the first detecting section 51 in the transportation direction. Specifically, the second detecting section 52 is located downstream of the first detecting section 51 by a distance equivalent to at least one rotation of the drive roller 61 and driven roller 62. In other words, the distance between the detection position (nip part 64) of the first detecting section 51 and the detection position of the second detecting section 52 is not less than the length of the circumference of the drive roller 61 and driven roller 62.

The second detecting section 52 includes a first detection unit 91 and a second detection unit 92. The first detection unit 91 is located on one side in the transportation path for the sheet S in the thickness direction and the second detection unit 92 is located on the other side in the transportation path for the sheet S in the thickness direction. The first detection unit 91 and second detection unit 92 face each other in the thickness direction of the sheet S with the transportation path between them.

The first detection unit 91 includes a light receiver 71 and a first light emitter 72 and the second detection unit 92 includes a second light emitter 73. The light receiver 71, located in the first detection unit 91, includes the light receiver for the basis weight detector 53 and the light receiver for the surface nature detector 54. The first light emitter 72, located in the first detection unit 91, includes the light emitter for the basis weight detector 53 and the light emitter for the surface nature detector 54. The second light emitter 73, located in the second detection unit 92, is the second light emitter for the basis weight detector 53.

The first light emitter 72 and second light emitter 73 irradiate the sheet S with light L. The light receiver 71 receives the reflected light L from the sheet S irradiated by the first light emitter 72 and the light L transmitted through the sheet S irradiated by the second light emitter 73. The basis weight detector 53 and the surface nature detector 54 detect the basis weight and surface nature of the sheet S according to the signal of the light received by the light receiver 71, respectively.

A detection guide plate 93 is located on one side of the first detection unit 91 which faces the second detection unit 92. The first detection unit 91 and detection guide plate 93 are rotatably supported by a hinge 95. As the first detection unit 91 and detection guide plate 93 are rotated around the hinge 95, the first detection unit 91 and detection guide plate 93 are moved away from the transportation path, thereby generating an open space above the second detection unit 92. This makes it easy to remove the paper remaining in the second detecting section 52 in case of a paper jam in the second detecting section 52.

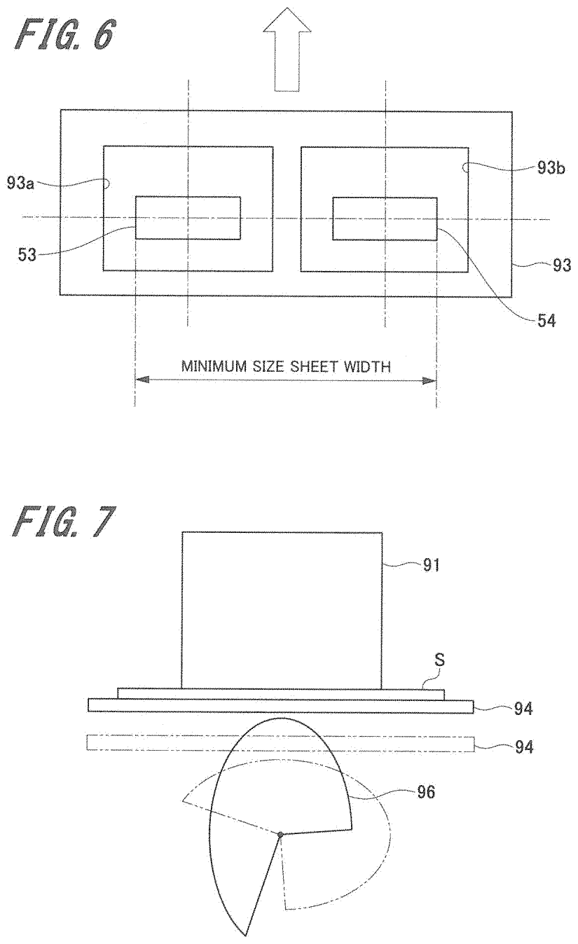

FIG. 6 is a plan view of the detection guide plate 93.

As shown in FIG. 6, the detection guide plate 93 has a first opening 93a and a second opening 93b. The basis weight detector 53 faces the first opening 93a and the surface nature detector 54 faces the second opening 93b.

The first opening 93a and second opening 93b are located on the both sides in the width direction of the detection guide plate 93. The first opening 93a and second opening 93b are located in the same position in the transportation direction of the sheet S. Consequently, the position of detection by the basis weight detector 53 in the transportation direction of the sheet S is almost identical to the position of detection by the surface nature detector 54 in the transportation direction of the sheet S, thereby leading to improvement in the detection accuracy for the sheet S.

The distance between the first opening 93a and second opening 93b in the width direction, namely the distance between the basis weight detector 53 and surface nature detector 54 in the width direction is shorter than the width of the minimum size sheet S.

A lifting member 94 almost like a flat plate is located on one side of the second detection unit 92 which faces the first detection unit 91.

FIG. 7 is a schematic structure diagram which shows the lifting member 94 and first detection unit 91.

As shown in FIG. 7, the lifting member 94 is movably supported by a lifting mechanism 96 so that the lifting member 94 can move toward and away from the first detection unit 91, namely it can move in the thickness direction of the sheet S. A rotatable cam member is used as the lifting mechanism 96. As the cam member is rotated, the lifting member 94 moves toward or away from the first detection unit 91. As a result, the sheet S placed on the lifting member 94 is pressed against the first detection unit 91.

Although in the present embodiment it is assumed that a cam member is used as the lifting mechanism 96, the present invention is not so limited. Instead, any of other various mechanisms such as a gear and a ball screw shaft may be used.

The lifting member 94 and lifting mechanism 96 are installed in the second detection unit 92, located opposite to the first detection unit 91 in which the light receiver 71 is installed. This prevents the influence that a drive noise generated by activation of the lifting mechanism 96 may give to the light receiver 71 and thus suppresses the deterioration in the detection accuracy.

In the present embodiment, it is assumed that the first detection unit 91 is rotatably supported by the hinge 95 and the first detection unit 91 is moved toward and away from the transportation path, but the present invention is not so limited. Instead, for example, the second detection unit 92 may be rotatably supported by the hinge 95 and the second detection unit 92 may be moved toward and away from the transportation path. In that case, if a paper jam occurs, an open space is generated below the first detection unit 91 by rotating the second detection unit 92 and thus the remaining sheet S can be easily removed.

### 3. Light Quantity Adjustment of the Second Detecting Section

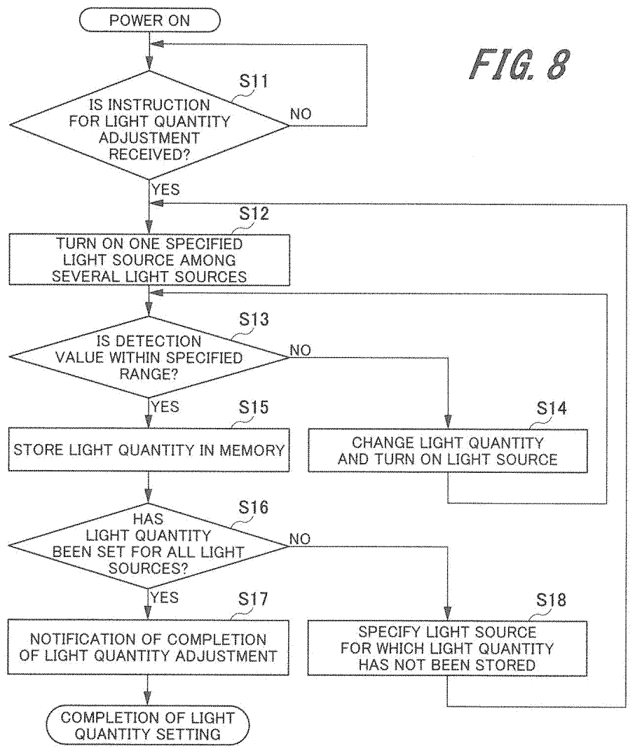

Next, the adjustment process of the second detecting section 52 structured as mentioned above will be described referring to FIG. 8.

FIG. 8 is a flowchart which shows the adjustment process (second adjustment process) of the second detecting section 52. The flowchart shown in FIG. 8 concerns the process to adjust the light quantity.

As shown in FIG. 8, when the image forming apparatus 20 or the sheet detection device 50 is turned on, the controller 200 decides whether an instruction to adjust the light quantity for the second detecting section 52 has been received or not (Step S11). If it is decided that the instruction to adjust the light quantity has been received (YES at Step S11), the second detecting section 52 turns on the light source specified by the controller 200, among the light sources which constitute the first light emitter 72 and second light emitter 73 with a specified value (quantity of light) (Step S12).

Then, the controller 200 decides whether the detection value received by the light receiver 71 is within a specified range or not (Step S13). If it is decided at Step S13 that the detection value is out of the specified range (NO at Step S13), the second detecting section 52 changes the light quantity and turns on the light source (Step S14).

If it is decided at Step S13 that the detection value is within the specified range (YES at Step S13), the controller 200 stores the light quantity in the memory 250 (Step S15). Then, the controller 200 decides whether the light quantity has been set for all the light sources of the second detecting section 52 or not (Step S16).

If it is decided at Step S16 that the light quantity has been set for all the light sources (YES at Step S16), the controller 200 notifies that the light source adjustment of the second detecting section 52 is completed (Step S17). This concludes the light quantity adjustment of the second detecting section 52.

If it is decided at Step S16 that the light quantity has not been set for all the light sources (NO at Step S16), the controller 200 specifies the light source for which the light quantity has not been stored (Step S18) and the process returns to Step S12. At Step S12, the light source specified at Step S18 is turned on.

As mentioned above, the detection accuracy can be assured by the light quantity adjustment of the second detecting section 52. In addition, since the second detecting section 52 is located more downstream than the first detecting section 51 in the transportation direction as shown in FIG. 3, it takes time for the sheet S transported from the paper feed unit 10 or paper feed tray to arrive at the second detecting section 52. The light quantity adjustment process shown in FIG. 8 is performed in a period before the sheet S transported from the paper feed unit 10 or paper feed tray arrives at the second detecting section 52, thereby preventing the decline in productivity.

In order to keep the detection accuracy in detection by the second detecting section 52 constant, a predetermined quantity of light is required. For this reason, it takes time to make the light quantity adjustment as the adjustment process of the second detecting section 52 (second adjustment process). On the other hand, the first detecting section 51 has only to detect the amount of change when a physical change occurs. The adjustment process of the first detecting section 51 (first adjustment process) may be, for example, a position adjustment such as an adjustment to set the drive roller 61, driven roller 62 and detection lever 81 to the home position. Therefore, the adjustment process of the first detecting section 51 (first adjustment process) can be performed in a shorter time than the light quantity adjustment as the adjustment process of the second detecting section 52 (second adjustment process).

### 4. An Example of Detection Operation

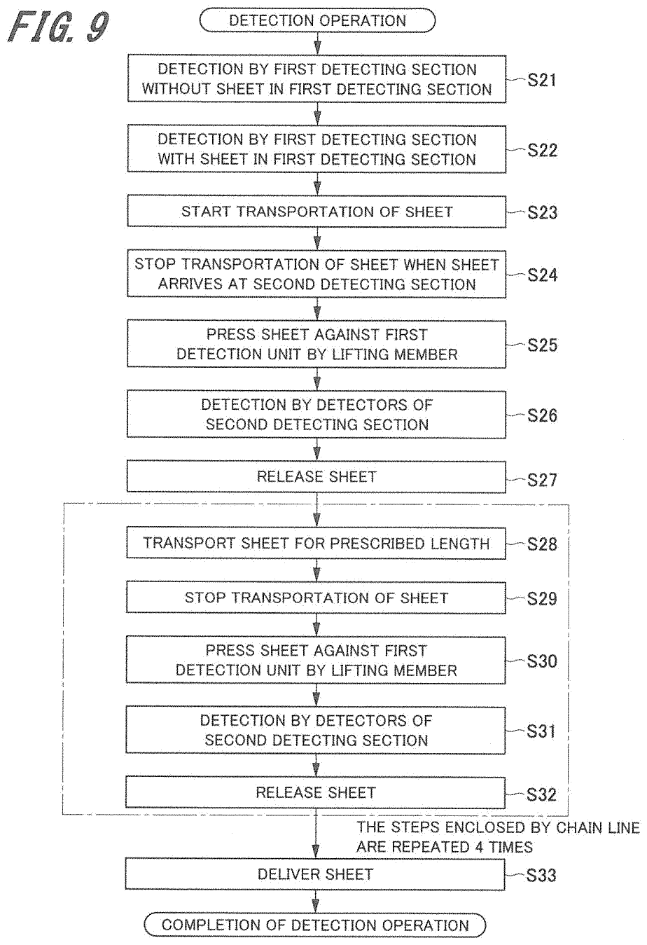

Next, an example of detection operation of the sheet detection device 50 structured as mentioned above will be explained referring to FIG. 9.

FIG. 9 is a flowchart which shows an example of detection operation.

As shown in FIG. 9, when the sheet S does not arrive at the first detecting section 51, the first detecting section 51 makes a detection (Step S21). Specifically, when the sheet S does not arrive at the nip part 64, the drive roller 61 is rotated so that the displacement detector 63 detects the displacement of the driven roller 62 in the thickness direction.

Then, when the sheet S passes through the first detecting section 51, namely when the sheet S arrives at the nip part 64, the first detecting section 51 makes a detection (Step S22). Specifically, when the sheet S is nipped by the nip part 64, the displacement detector 63 detects the displacement of the driven roller 62 in the thickness direction. Consequently, the thickness of the sheet S can be detected from the detection information obtained at Step S21 and the detection information obtained at Step S22. Then, the detection result is stored in the memory 250.

As mentioned above, the second detecting section 52 is located more downstream than the first detecting section 51 in the transportation direction, so the adjustment process shown in FIG. 8 can be performed during the period of Step S21 and Step S22. Consequently, detection operation can be performed without stopping operation of the sheet detection device 50, thereby preventing the decline in productivity.

Then, the drive roller 61 is rotated so that the first detecting section 51 starts transportation of the sheet S (Step S23). Then, as the sheet S arrives at the second detecting section 52, rotation of the drive roller 61 is stopped to stop the transportation of the sheet S (Step S24). The second detecting section 52 makes a detection of the sheet S with the sheet S nipped between the drive roller 61 and driven roller 62 of the first detecting section 51.

Then, the sheet S is pressed against the first detection unit 91 by the lifting member 94 (Step S25). Specifically, as shown in FIG. 7, the lifting mechanism 96 is rotated to move the lifting member 94 toward the first detection unit 91.

Then, the basis weight detector 53 and surface nature detector 54 of the second detecting section 52 make a detection of the sheet S (Step S26). At Step S26, the light emitter of the basis weight detector 53 and that of the surface nature detector 54 should emit light at different timings. In other words, the controller 200 controls operation of the basis weight detector 53 and operation of the surface nature detector 54 so that they detect the sheet S at different timings. This prevents the deterioration in detection accuracy because the light receiver of the basis weight detector 53 or the light receiver of the surface nature detector 54 does not receive light from the light emitter of the other detector.

In addition, in the basis weight detector 53, the first light emitter 72, which makes the sheet S reflect light, and the second light emitter 73, which makes the sheet S transmit light, emit light at different timings. This eliminates the possibility that when the light receiver 71 should receive the reflected light, it receives the transmitted light or when the light receiver 71 should receive the transmitted light, it receives the reflected light, thereby preventing the deterioration in detection accuracy.

After the detection process by the detectors at Step S26 is finished, the controller 200 drives the lifting mechanism 96 to release the sheet S pressed against the first detection unit 91 (Step S27). In other words, the lifting mechanism 96 is driven to move the lifting member 94 away from the first detection unit 91.

Then, the controller 200 rotates the drive roller 61 of the first detecting section 51 and transports the sheet S for a prescribed length (Step S28). After the sheet S is transported for the prescribed length, the controller 200 stops the rotation of the drive roller 61 to stop the transportation of the sheet S (Step S29).

Then, the sheet S is pressed against the first detection unit 91 by the lifting member 94 (Step S30) and the basis weight detector 53 and surface nature detector 54 of the second detecting section 52 detect the sheet S (Step S31). As Step S31 is finished, the sheet S is released from the first detection unit 91 (Step S32). Then, the controller 200 repeats the steps from Step S28 to Step S32 four times.

In other words, the second detecting section 52 makes a detection at five points of the sheet S along the transportation direction. Then, the controller 200 calculates the average of detection values at three points, except the maximum and minimum detection values among the detection values at the five points as detected by the second detecting section 52. The controller 200 detects the basis weight and surface nature of the sheet S from the calculated average. Then, the detection result is stored in the memory 250.

The number of detection points at which the second detecting section 52 makes a detection is not limited to 5 but it may be 4 or less or 6 or more. In the above example, the average of detection values at a plurality of points except the maximum and minimum detection values is calculated, but the present invention is not so limited. Instead, the average of all detection values may be calculated or any other algorithm may be adopted.

Then, when the number of times of detection by the second detecting section 52 reaches a prescribed number of times (five times in the present embodiment), the controller 200 rotates the drive rollers 61 of the first detecting section 51 and the conveyor rollers 57 to deliver the sheet S from the sheet detection device 50 (Step S33). This concludes the operation of the sheet detection device 50 to detect the sheet S. The sheet S delivered from the sheet detection device 50 is transported to the image forming section 270.

### 5. Change in the Quantity of Light and the Position of Incidence Depending on the Sheet Thickness

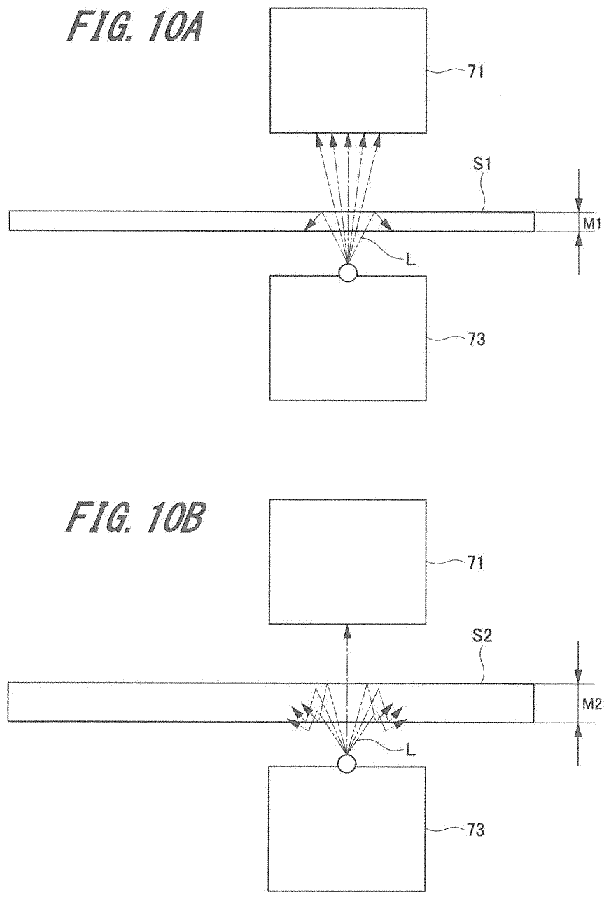

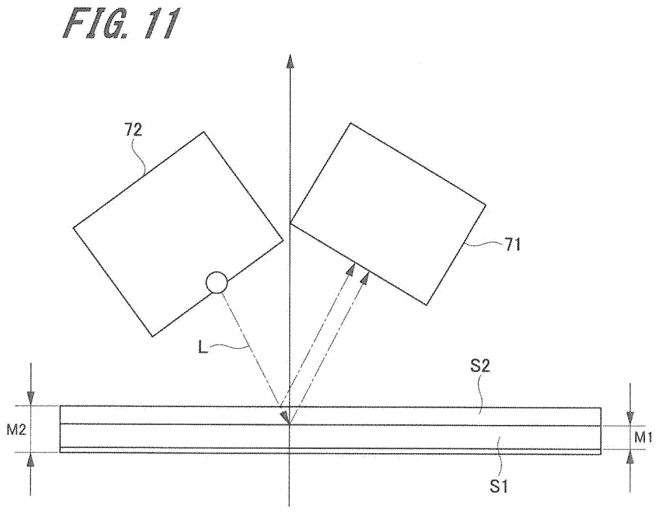

Next, how the quantity of light and the position of incidence change depending on the sheet thickness will be explained referring to FIG. 10A to FIG. 11.

FIG. 10A and FIG. 10B are explanatory diagrams which indicate that the quantity of transmitted light differs depending on the sheet thickness. FIG. 11 is an explanatory diagram which indicates that the position of incidence of reflected light on the light receiver differs depending on the sheet thickness.

Thickness M1 of a first sheet 51 shown in FIG. 10A is smaller than thickness M2 of a second sheet S2 shown in FIG. 10B. As shown in FIG. 10A and FIG. 10B, the quantity of light L which passes through the second sheet S2 and arrives at the light receiver 71 is smaller than the quantity of light L which passes through the first sheet 51 and arrives at the light receiver 71. Therefore, the accuracy of detection by the basis weight detector 53 is decreased.

In addition, when reflected light is used to detect the physical property value of the sheet, as shown in FIG. 11, since the first sheet 51 and second sheet S2 are different in thickness, the distance from the first light emitter 72 to the reflecting surface of the sheet 51 is different from that to the reflecting surface of the sheet S2. Therefore, the position of incidence of the light L reflected by the sheet 51 on the light receiver 71 is different from that of the light L reflected by the sheet S2, so the accuracy of detection by the basis weight detector 53 and the surface nature detector 54 is decreased.

### 6. Another Example of Detection Operation

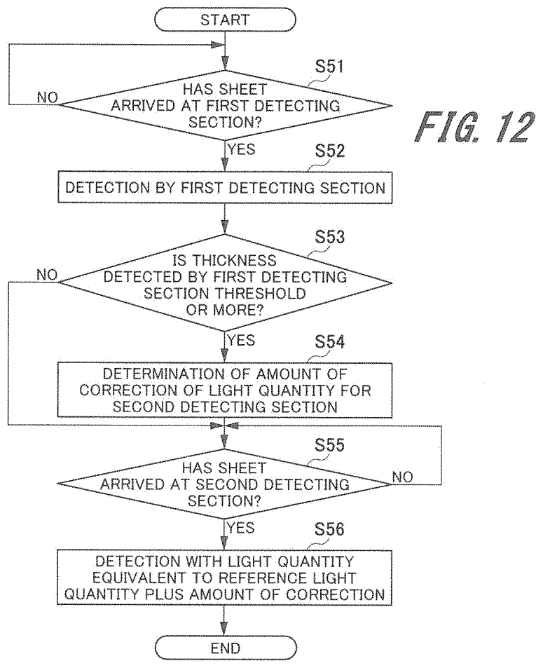

Next, another example of detection operation which takes the sheet thickness difference as mentioned above into consideration will be explained referring to FIG. 12.

FIG. 12 is a flowchart which shows another example of detection operation.

As shown in FIG. 12, the controller 200 decides whether the sheet S has arrived at the nip part 64 of the first detecting section 51 (Step S51). If it is decided at Step S51 that the sheet S has arrived at the nip part 64 of the first detecting section 51 (YES at Step S51), the first detecting section 51 makes a detection of the sheet S (Step S52). Then, the first detecting section 51 sends the detection information to the controller 200. Since the operation of the first detecting section 51 to detect the sheet S is the same as the detection operation shown in FIG. 8, description thereof is omitted here.

Then, the controller 200 decides whether the thickness of the sheet S detected by the first detecting section 51 is a preset threshold or more, according to the detection information received from the first detecting section 51 (Step S53). If at Step S53 the controller 200 decides that the thickness of the sheet S is smaller than the threshold (NO at Step S53), Step S55 which will be described later is carried out.

If at Step S53 the controller 200 decides that the thickness of the sheet S is the threshold or more (YES at Step S53), the controller 200 determines the amount of correction of the quantity of light for the second light emitter 73 of the second detecting section 52 (Step S54). In the correction at Step S54, the controller 200 changes the detection gain (amplification factor) for the light receiver 71 to receive the reflected light.

Next, the controller 200 decides whether the sheet S has arrived at the second detecting section 52 or not (Step S55). If it is decided at Step S55 that the sheet S has arrived at the second detecting section 52 (YES at Step S55), the second detecting section 52 lights up the second light emitter 73 with a quantity of light equivalent to a reference light quantity plus the amount of correction determined at Step S54 and makes a detection of the sheet S (Step S56). If the thickness of the sheet S does not reach the threshold, the amount of correction is zero and the second light emitter 73 is lit up with the reference light quantity at Step S56.

At Step S56, if the first light emitter 72 is lit up and reflected light is received, the detection gain (amplification factor) for the light receiver 71 is changed depending on the thickness of the sheet S. This concludes the operation of the sheet detection device 50 to detect the sheet S.

As stated by the above detection operation, since the quantity of light for the second detecting section 52 is corrected depending on the thickness of the sheet S detected by the first detecting section 51, the accuracy of detection by the basis weight detector 53 and surface nature detector 54 of the second detecting section 52 can be improved.

In the above example, the quantity of light for the second light emitter 73 and the detection gain for the light receiver 71 are changed depending on the thickness of the sheet S. However, the present invention is not so limited. Instead, for example, the result of detection by the second detecting section 52 may be corrected according to the result of detection by the first detecting section 51, namely the thickness of the sheet S, without changing the quantity of light or the detection gain in advance.

So far, the embodiment and effects thereof have been described. However, the present invention is not limited to the above embodiment. The invention may be embodied in other various ways without departing from the gist of the invention as described in the appended claims.

Although in the above embodiment, four image forming units are used to form a color image, instead the image forming apparatus according to the present invention may use one image forming unit to form a monochrome image.

The display section which shows the result of detection by the sheet detection device 50 is not limited to the operation display panel 240. Instead, the display section of the external device (client terminal, management device server or the like or mobile terminal) which outputs job information to the image forming apparatus 20 may be used.

In the above example, it is assumed that the controller 200 which controls the entire image forming apparatus 20 is used as the controller which controls the sheet detection device 50. However, the invention is not so limited, and separately from the controller 200, a detection controller which controls the sheet detection device 50 may be provided. In that case, the detection controller performs transmission and reception of information as a detection result with the controller 200 and receives an instruction to adjust the quantity of light from the controller 200 or sends the detection result to the controller 200. Also, the detection controller stores the correction value for the second detecting section 52 in the memory 250.

The above elements, functions, processing sections, and so on may be, in part or in whole, implemented by hardware such as an integrated circuit. The above elements, functions, and so on may be implemented by software through a processor which interprets and executes the program to perform the functions. The information to perform the functions, such as programs, tables and files, may be stored in a recording device such as a memory, hard disk or SSD (Solid State Drive) or a recording medium such as an IC card, SD card or DVD.

In the above example, it is assumed that a sheet of paper is used as the recording medium, but the invention is not so limited. Instead, a film, cloth or another type of material may be used as the recording medium.

In this specification, the terms “parallel” and “perpendicular” are used, but these terms do not mean “exactly parallel” and “exactly perpendicular”, respectively. The meanings of the terms herein include not only “parallel” and “perpendicular” but also “almost parallel” and “almost perpendicular” to the extent that the functions can be performed.

Although an embodiment of the present invention has been described and illustrated in detail, the disclosed embodiment is made for purposes of illustration and example only and not limitation. The scope of the present invention should be interpreted by terms of the appended claims.

### REFERENCE SIGNS LIST

1 . . . image forming system,
10 . . . paper feed unit,
20 . . . image forming apparatus,
50 . . . sheet detection device (recording medium detection device),
51 . . . first detecting section,
52 . . . second detecting section,
53 . . . basis weight detector,
54 . . . surface nature detector,
57 . . . conveyor roller,
58 . . . transportation guide plate,
61 . . . drive roller (first roller),
62 . . . driven roller (second roller),
63 . . . displacement detector,
64 . . . nip part,
66 . . . roller shaft (displacement member),
66a . . . flat part,
67 . . . shaft support,
71 . . . light receiver,
72 . . . first light emitter,
73 . . . second light emitter,
81 . . . detection lever,
82 . . . support part,
91 . . . first detection unit,
92 . . . second detection unit,
93 . . . detection guide plate,
93a . . . first opening,
93b . . . second opening,
94 . . . lifting member,
95 . . . hinge,
96 . . . lifting mechanism,
250 . . . memory (storage),
260 . . . image processor,
270 . . . image forming section,
290 . . . inversion conveyor

What is claimed is:

1. A recording medium detection device comprising:
a first detecting section which performs a first adjustment process and makes a detection of a recording medium being transported; and
a second detecting section which is located more downstream than the first detecting section in a transportation direction of the recording medium and performs a second adjustment process which takes a longer time than the first adjustment process, and makes a detection of the recording medium being transported.

2. The recording medium detection device according to claim 1, wherein the first detecting section has a pair of rollers which nips and transports the recording medium.

3. The recording medium detection device according to claim 2, wherein the second detecting section makes a detection of the recording medium with the recording medium nipped by the pair of rollers of the first detecting section.

4. The recording medium detection device according to claim 2, wherein a distance between a detection position of the first detecting section and a detection position of the second detecting section is set to a length not less than a circumference of the rollers of the first detecting section.

5. The recording medium detection device according to claim 1, wherein
the first detecting section detects a thickness of the recording medium, and
the second detecting section comprises:
a basis weight detector to detect basis weight of the recording medium; and
a surface nature detector to detect a surface nature of the recording medium.

6. The recording medium detection device according to claim 5, wherein a detection position of the basis weight detector and a detection position of the surface nature detector are identical in the transportation direction of the recording medium.

7. The recording medium detection device according to claim 5, further comprising a controller which controls the second detecting section, wherein
the controller controls so that operation of the basis weight detector to detect the recording medium and operation of the surface nature detector to detect the recording medium are performed at different timings.

8. The recording medium detection device according to claim 1,
the second detecting section comprising:
a light emitter which irradiates the recording medium with light; and
a light receiver which receives the light transmitted or reflected by the recording medium.

9. The recording medium detection device according to claim 8,
the second detecting section comprising:
a first detection unit which is located on one side in a thickness direction of the recording medium in a transportation path in which the recording medium is transported; and
a second detection unit which faces the first detection unit in the thickness direction of the recording medium and is located on the other side in the thickness direction of the recording medium in the transportation path.

10. The recording medium detection device according to claim 9, wherein
the second detecting section comprises a lifting member and a lifting mechanism to press the recording medium which passes through the transportation path against the first detection unit, and
the light receiver is located in the first detection unit.

11. The recording medium detection device according to claim 9, wherein at least one of the first detection unit and the second detection unit is rotatably supported by a hinge and moves toward and away from the transportation path.

12. The recording medium detection device according to claim 1, further comprising:
a controller which controls the first detecting section and the second detecting section, wherein
the controller changes a detection condition of the second detecting section or corrects detection information detected by the second detecting section according to detection information from the first detecting section.

13. An image forming apparatus comprising:
an image forming section which forms an image on a recording medium; and
a recording medium detection device which is located more upstream than the image forming section in a transportation direction of the recording medium and detects the recording medium,
the recording medium detection device comprising:
a first detecting section which performs a first adjustment process and makes a detection of the recording medium being transported; and
a second detecting section which is located more downstream than the first detecting section in the transportation direction of the recording medium, performs a second adjustment process which takes a longer time than the first adjustment process, and makes a detection of the recording medium being transported.
